(19) United States
(12) Patent Application Publication
(10) Pub. No.: US 2012/0269035 A1
(43) Pub. Date: Oct. 25, 2012

(54) Evaluating Prospects from P-Wave Seismic Data Using S-Wave Vertical Shear Profile Data

(76) Inventor: Alan J. Foley, Houston, TX (US)

(21) Appl. No.: 13/272,611

(22) Filed: Oct. 13, 2011

Related U.S. Application Data
(60) Provisional application No. 61/409,721, filed on Nov. 3, 2010.

(51) Int. Cl. G01V 1/28

(52) U.S. Cl. 367/75

(57) ABSTRACT

The present disclosure relates to methods and systems for evaluating potential hydrocarbon prospect locations within a subsurface formation. First and second opposite polarity directional seismic signals are propagated from a seismic source through the subsurface formation and recorded. A pure shear wave record is derived from the recorded signals and compared to a compression wave record for at least one potential hydrocarbon reservoir location within the formation.

### CROSS-REFERENCE TO OTHER APPLICATIONS

This application claims, under 35 U.S.C. §119(e), priority to and the benefit of U.S. Provisional Application No. 61/409,721, filed Nov. 3, 2010.

### BACKGROUND

1. Technical Field

The present disclosure relates generally to seismic geophysical exploration, and particularly to techniques for identifying and evaluating prospective locations for hydrocarbon reservoirs within a formation of interest.

2. Background Art

Seismic surveying is widely used to explore buried hydrocarbon reservoirs. Traditional seismic surveys have been recorded using geophones and hydrophones. A geophone measures the displacement or velocity of the earth to which the geophone is adjoined, while a hydrophone measures pressure changes in the fluid in which the hydrophone is immersed. These seismic receivers may be deployed along the earth's surface, in the ocean, or in a wellbore to perform seismic surveys. Seismic sources, whether individually or in an array, are commonly deployed on or near the earth's surface or in the ocean.

Seismic signals include a composite of compression (P-waves), shear waves (S-waves) and background noise; in some areas P-waves are converted to S-waves at formation interfaces and are referred to as converted waves. Shear waves are characterized as responding to lithology alone and are used by engineers to estimate the mechanical properties of formations. Compression waves respond to the lithology and the fluids contained by the formations, which accounts for their widespread use in exploration and development of oil and gas reservoirs.

### SUMMARY OF THE INVENTION

The present disclosure relates to methods for identifying and evaluating prospective locations within a subsurface formation wherein a seismic source propagates first and second directional seismic signals of opposite polarity through a subsurface formation. The first and second directional seismic signals are then recorded. The first and second directional signals are then processed so that the compression wave and converted wave data and noise are removed from the combined signal to yield a pure shear wave record. Thereafter, a vertical shear profile record based upon the pure shear wave record is compared with compression wave record for potential locations within the formation of interest.

The invention also provides a shear wave acquisition system which can obtain shear wave seismic data from a subsurface formation. Exemplary systems include a seismic signal generator that can transmit through the subsurface formation first and second directional seismic signals that are opposite in polarity. Described systems also include a receiver to receive the first and second signals and processing means to extract a pure shear wave record from a combined signal made up from the first and second signals.

The present invention provides methods of seismic surveying for a formation of interest. In accordance with preferred methods directional shear waves are measured at or proximate the surface of the formation. According to described methods, this is done by propagating first and second directional signals of opposite polarity from a signal generator and recording the direct and reflected signals with one or more recorders that are located at or near the surface. In certain embodiments, the signal generator is rotated ninety degrees, and third and fourth directional signals of opposite polarity are generated. The direct and reflected signals are then also recorded with one or more recorders that are located at or near the surface.

The one or more recorders are then lowered a predetermined interval into the earth. Thereafter, first and second directional signals are again propagated by the signal generator, and recorded by the one or more recorders. In some embodiments, the signal generator is then rotated ninety degrees, and the third and fourth directional signals are propagated. This sequence is repeated until the desired depth is reached.

A P-wave surface seismic survey of the location of interest is recorded to identify drilling targets, known as “prospects”. One or more potential subsurface prospect locations within the survey are then identified based upon this P-wave response. In accordance with the present invention, a second shear wave record is then developed for the formation of interest. Opposite polarity signals are reversed and summed removing the P-wave data. Preferably, noise is also removed, leaving a vertical shear profile record substantially composed of pure S-wave response within the formation of interest. The vertical shear profile record is then compared to the compression wave survey record at the potential prospect locations. An S-wave response matching the P-wave response at the potential prospect location indicates the P-wave anomaly which defines the prospect is more probably caused by the subsurface lithology, rather than the presence of fluids. The absence of an S-wave response at a potential prospect location indicates the presence of fluids causing the P-wave anomaly which defines the prospect.

According to other aspects of the present invention, the P-wave and S-wave records are recorded in sufficient detail and over a length of time that permits the records to be clearly read and potential prospects within the records to be clearly identified. In preferred embodiments, the minimum length of signal recording time for the shear profile is at least from about 5,000 mS to about 10,000 mS. Also in accordance with particular embodiments, the detected signals are recorded with at least a 32-bit recorder accuracy, which is capable of recording such signals in a high fidelity manner.

In addition to the method of direct comparison between the vertical shear profile and the compression wave seismic survey a technique of developing three derived profiles from the vertical shear profile is presented. These derived profiles are the reflection coefficient profile, the velocity profile and the amplitude profile. These derived profiles allow a direct comparison of the shear wave response with the compression wave response of a subsurface formation. Other aspects and advantages will become apparent from the following description and the attached claims.

### BRIEF DESCRIPTION OF THE FIGURES

FIG. 1 illustrates an exemplary shear wave acquisition system using a geotechnical Seismic Cone Truck equipped with a Seismic Cone Penetrometer Tool (SCPT) and a shear beam source to generate and record shear wave reflection data using three-component geophones planted in the soil, in accordance with the present disclosure.

FIG. 2 is a top view of portions of an exemplary signal generator as used in accordance with the present invention.

FIG. 3 is a side, cross-sectional view of a seismic surveying arrangement in accordance with the present invention.

FIG. 4 is a plot showing the recorded amplitudes of waveforms versus time resulting from activation of a left polarity source and a right polarity source, in accordance with the present disclosure.

FIG. 5 is a set of exemplary records showing the field records, the summed record with the shear data canceled out, and the pure shear wave record derived by removing the derived, summed record, in accordance with the present disclosure.

FIG. 5A is an exemplary gather of multi-level S-wave shots in two-way time and stacks.

FIG. 6 is an illustrative comparison of surface seismic and vertical shear profile data.

### DETAILED DESCRIPTION OF THE PREFERRED EMBODIMENTS

Some embodiments will now be described with reference to the figures. Like elements in the various figures will be referenced with like numbers for consistency. In the following description, numerous details are set forth to provide an understanding of various embodiments and/or features. However, it will be understood by those skilled in the art that some embodiments may be practiced without many of these details and that numerous variations or modifications from the described embodiments are possible. As used here, the terms “above” and “below”, “up” and “down”, “upper” and “lower”, “upwardly” and “downwardly”, and other like terms indicating relative positions above or below a given point or element are used in this description to more clearly describe certain embodiments. However, when applied to equipment and methods for use in wells that are deviated or horizontal, such terms may refer to a left to right, right to left, or diagonal relationship as appropriate.

The advent of engineering techniques for producing natural gas from massive shale bodies has given rise to a need to evaluate the characteristics of in-situ fluids to maximize drilling and fracturing efficiency. In addition, a seismic survey from which shear wave data is isolated can be used by geoscientists to determine, for example, optimal drilling locations, locations for additional study, or whether to acquire land for resource development.

Direct earth formation seismic shear wave data can be acquired using a variety of seismic sources, such as impulsive or continuous sources. Impulsive sources include, but are not limited to, explosives and “thumpers”. Continuous seismic sources include, but are not limited to, vibrators, “chirps”, and random impulse generators. Any of those sources can be tailored, for example, to the depth of the objective and environmental conditions on the surface. Those sources typically produce a combination of shear and compression waves that pass through the earth. However, in described embodiments, the seismic sources are seismic signal generators that are capable of producing directional seismic signals of opposing polarities. In the event that no P-wave seismic surveys are available over the location of interest a P-wave source may be used in addition to the S-wave source to produce a P-wave VSP for comparison with the S-wave data.

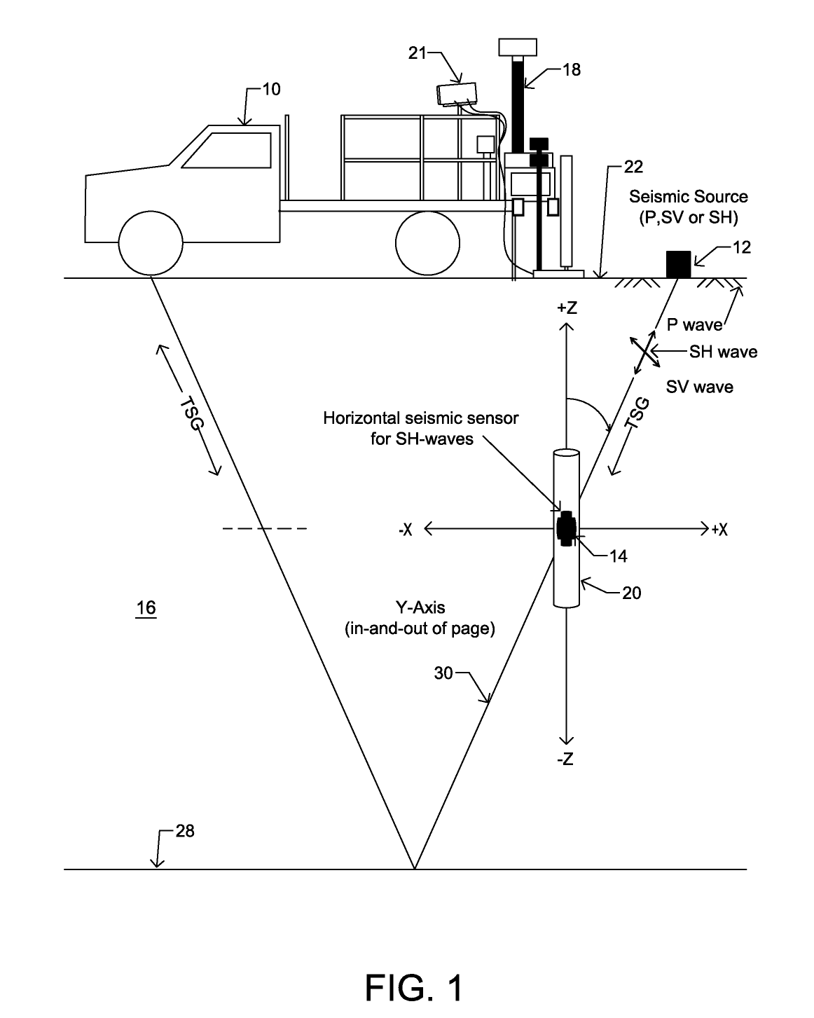

FIG. 1 illustrates an exemplary shear wave acquisition system using a geotechnical Seismic Cone Penetrometer Tool (SCPT) cone truck 10 with a shear beam 12 to generate and record shear wave reflection data using one or more signal recorders, such as three-component geophones. A single three-component geophone 14 seismic signal detector is shown disposed within the earth 16 in FIG. 1. In particular embodiments, methods of the present invention measure the travel times T_{SG} of seismic energy from the source to its arrival at the geophone 14. Those of skill in the art will understand that, while a geophone 14 is specifically described herein, that is by means of example only and that other suitable signal receivers may also be used, such as accelerometers, and gravity receivers and the like. The geophone 14 is operably associated with suitable seismic recording and processing equipment, such as a suitably programmed computer 21 at the surface 22. The SCPT cone truck 10 typically carries penetrometer hydraulic rams, generally indicated at 18, that are designed to urge a housing 20 containing the one or more geophones 14 downwardly from the surface 22 through the earth formation 16.

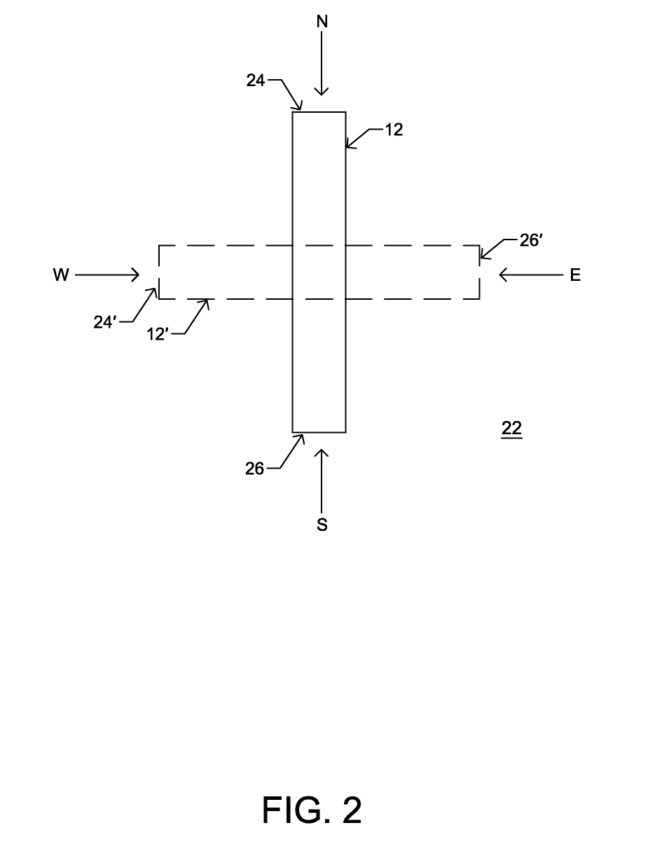

Directional shear waves are propagated from the shear beam 12 at the surface 22, detected by geophone 14, and recorded by recording and processing equipment 21. The shear beam source 12 preferably comprises a solid beam that generates a seismic or acoustic signal that is propagated through the earth formation 16. For example, an impulsive signal may be generated when shear beam 10 is struck with an impacting member, such as a hammer, manually or otherwise. The exemplary acoustic signal source shear beam 12 is better appreciated with reference to FIG. 2 which depicts a top view of the shear beam 12. The shear beam 12 is elongated and presents opposite first and second axial ends 24, 26. The shear beam 12 is initially disposed in a first orientation as depicted in the solid lines, in a generally north-south orientation. The first end 24 of the shear beam 12 is impacted to create a first directional seismic signal. The second end 26 is impacted to create a second directional seismic signal that is opposite in polarity to the first directional seismic signal.

FIG. 2 also depicts particular embodiments of methods of the present invention wherein the shear beam 12 has been rotated ninety degrees from the north-south orientation to be in a second orientation (indicated as 12′) so that the shear beam 12 is disposed in an east-west configuration. It is noted, that the designations of “north-south” and “east-west” are exemplary only for purposes of explanation. It is not necessary that the shear beam 12 have any specific orientations with respect to true or magnetic north or other coordinates or azimuths relative to the Earth. It is merely significant that the first and second orientations be generally orthogonal to one another. The first orientation might, for example, dispose the shear beam in a N-E to S-W direction and the second orientation would be in a N-W to S-E direction. In those embodiments wherein the shear beam 12 is rotated to the second orientation 12′, opposite polarity third and fourth directional seismic signals are generated and propagated through the formation 16 in the same manner as the first and second directional seismic signals described herein. The third and fourth directional seismic signals may then be processed and analyzed in the same manner as will be described herein with respect to the first and second directional seismic signals.

In preferred embodiments, the seismic signals generated by impacting the shear beam 12 and the resulting direct arrivals and subsurface reflections of the generated signal are recorded on a seismograph recording system. FIG. 1 illustrates an exemplary reflector 28 that reflects the propagated signal 30. The reflector 28 is representative of one of many layers or interfaces within the earth formation 16 which will tend to reflect the signal 30. The recorded record for the first directional seismic signal, produced by impacting the first end 24 of the shear beam 12 is considered a “positive polarity” record. The shear beam 12 is then impacted with a hammer at the shear beam 12's opposite end 26 to produce a “negative polarity” record. Such “shots” of opposite polarities are repeated and each record of the same polarity is recorded until a suitable signal from the target formation is obtained for each polarity. This process may produce a single record or a plurality of records.

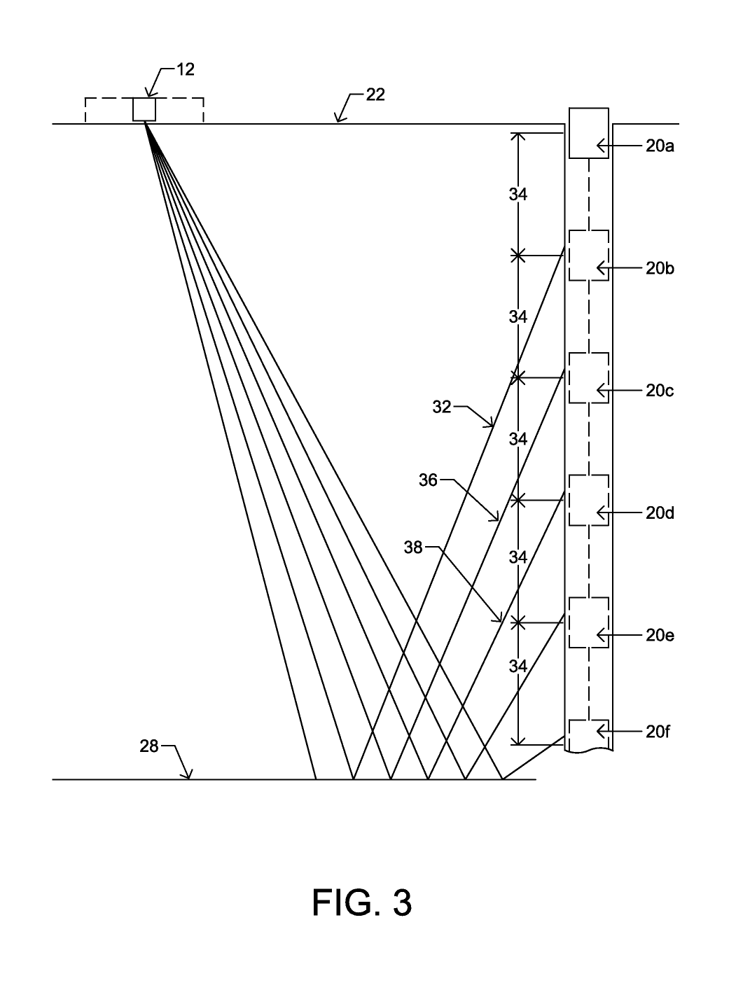

In accordance with particular embodiments of the invention, the one or more geophones 14 are generally positioned within the housing 20 and are initially disposed at or proximate the level of the surface 22, as depicted in FIG. 3. This initial, first location is denoted by 20a in FIG. 3. The first and second opposite polarity directional seismic signals are then generated from the shear beam 12 as described and are recorded by the one or more geophones 14 within the housing 20 in the first position 20a. The first and second directional seismic signals are illustrated schematically by arrow 32 in FIG. 3 which is shown reflected by reflector 28. However, those of skill in the art will understand that the housing 20/geophones 14 will receive and record direct signals as well as the depicted reflected signals.

The housing 20 is then moved downwardly within the earth formation 16 by rams 18 to a second location, which is denoted as 20b in FIG. 3. It is noted that the first and second locations 20a, 20b are preferably separated by a predetermined interval 34. In a currently preferred embodiment, the predetermined interval 34 is about 10 feet. However, other suitable intervals might be used. With the housing 20/geophones 14 at the second location 20b, first and second directional signals are again propagated through the earth formation 16 from the shear beam 12, as described previously. These signals, indicated schematically by arrow 36 in FIG. 3, are recorded by the one or more geophones 14 within the housing 20.

Next, the housing 20 is moved downwardly within the earth formation 16 a further predetermined interval 34 to a third location 20c. First and second directional seismic signals are again generated using the shear beam 12 and propagated through the earth formation 16, as shown schematically by arrow 38. These signals are then recorded by the one or more geophones 14 within the housing 20.

The process may be repeated with the housing 20 moved downwardly to fourth location 20d, fifth location 20e, sixth location 20f, and so forth until the desired depth of surveying for the formation 16 is reached.

Further in accordance with particular embodiments of the present invention, the first and second directional signals are each recorded for at least a minimum length of time. In currently preferred embodiments, the length of recording is at least from about 5,000 mS to about 10,000 mS. Additionally, it is currently preferred that the detected signals be recorded by at least a 32-bit recorder which is capable of recording such signals in at least a 32-bit, high fidelity manner.

The following description of manipulations of the field recordings, referred to as field records, will be familiar to those of skill in the art. The manipulations may be performed on computer systems designed for the purpose of processing seismic recordings by means of proprietary software such as ProMAX™, SeisUP™ or VISTA™ systems. These systems operate on arrays of digitized numbers recorded from the geophone(s) 14 disposed in the earth and are sampled, initially, in time. Shear wave data are sampled in shear wave time and P-wave data are sampled in P-wave time; owing to the differing velocities of the types of waves these times cannot be compared directly. An alternative rendition of this situation is that shear wave reflections from a reflector at a specific depth below the surface arrive at a different, usually later, time than P-wave reflections from the identical reflector. According to aspects of described methods, one compares S-wave reflections with P-wave reflections from the same reflector and draws conclusions about the nature of that reflector and the fluids contained therein.

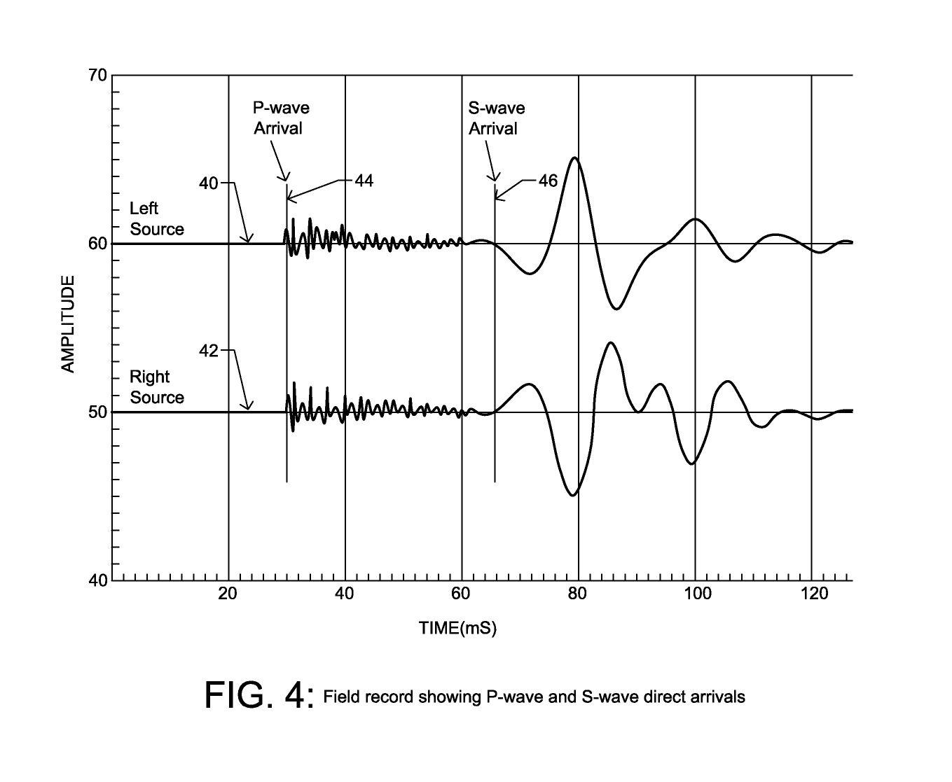

As is known in the art, longitudinal or compression waves generally travel faster than transverse waves. Thus, records generally show the arrival of the longitudinal wave, followed by the arrival of the secondary (transverse) wave. A particular wave-type may comprise direct waves, reflected waves, and refracted waves. The records show the arrival times of the various waves. For example, a record may show the shear wave direct arrival followed by the reflected shear wave. FIG. 4 illustrates a field record generated which includes a first directional signal trace (Left Source) 40 and a second, opposite polarity directional signal trace (Right Source) 42. As depicted, the P-wave arrives at the geophone 14 at point 44 ahead of the S-wave (arriving at point 46). It can also be appreciated from reference to FIG. 4 that the S-waves resulting from the first and second directional signals are virtual mirror images of one another.

In a preferred embodiment, both polarities of the shear waves (“S-waves”) from the source are preserved. This produces two distinct signals that may be used to discriminate differing subsurface formations based on their varying responses to the polarized signals. FIG. 4 shows two traces of opposite polarity shear recordings that are used to remove compression wave signals and noise to derive a “pure shear wave record”. It can be seen that the P-waves are similar, at least in major features, and are in phase. It can also be seen that the S-waves are very similar, but out of phase by substantially 180 degrees.

Preferably, the recorded data is edited by the seismic recording and processing equipment 21 to remove any noisy traces and filtered to reduce noise. Corresponding opposite polarity shear records are then summed to remove the (polarized) shear energy and produce a measurement of the compression (“P-wave”) and converted compression-to-shear vertical (“P-to-SV-wave” or “C-wave”) data only. The seismic recording and processing equipment 21 preferably includes a suitable processing means for carrying out these steps, such as a programmable processor within a computer workstation with suitable signal processing software.

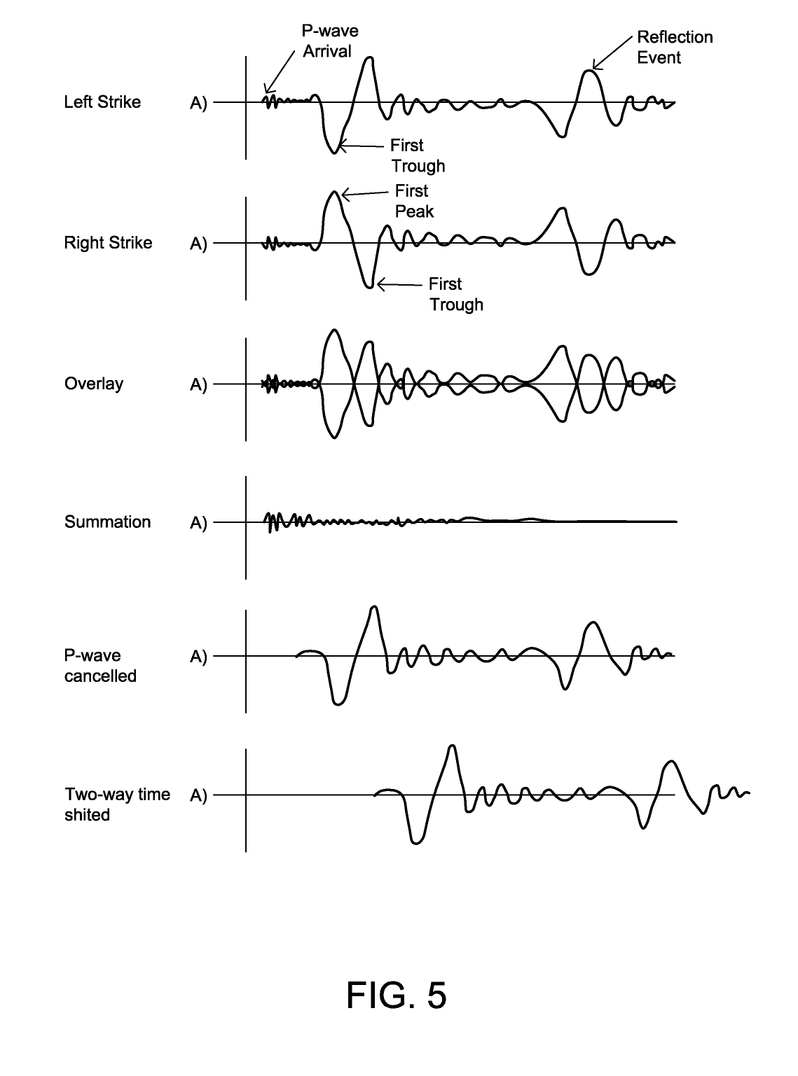

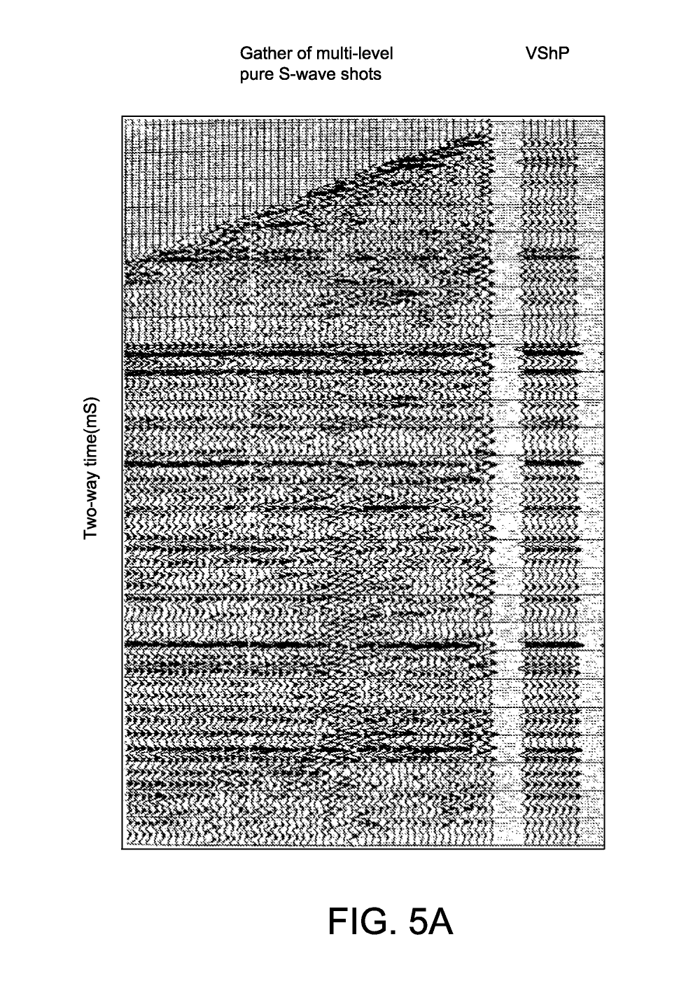

The theory underlying that process is illustrated in FIG. 5. Plot A of FIG. 5 shows a representative trace resulting from a left strike polarity pulse, and Plot B of FIG. 5 shows a representative trace resulting from a right strike polarity pulse. Those traces may be plotted overlaying one another, as shown in Plot C of FIG. 5. The overlay plot shows how, if combined, certain portions of the traces would constructively interfere (i.e., are in phase) and other portions would destructively interfere (i.e., are 180 degrees out of phase). Plot D of FIG. 5 expressly shows such interference when the two traces are added together. The resulting waveform includes the in-phase contributions from the P-waves, but does not retain the out-of-phase contributions from the S-waves. If that resulting waveform is inverted (i.e., all amplitude values multiplied by negative one) and added to the left strike polarity pulse trace, the P-wave and non-random noise are removed, leaving a pure shear wave trace, as shown in Plot E of FIG. 5. A similar, but opposite polarity, pure shear wave could be produced by adding the inverted resultant waveform of Plot D (of FIG. 5) to the right strike polarity trace of Plot B (of FIG. 5).

Further, the produced pure shear wave can be shifted in time to account for the two-way travel time that would be expected for a reflected signal to return to the earth's surface, as shown in Plot F of FIG. 5. That is, the travel time from the source to the reflector to the geophone (“S-R-G”) is recorded (i.e., measured), as is the travel time of the direct arrival of the source signal at the (buried) geophone. The travel time for the direct arrival is added to the measured S-R-G travel time to approximate the missing return leg to the earth's surface. If the angle of reflection is not large, the direct arrival travel time will closely approximate the missing return leg travel time. The time shifting can facilitate the comparison of the pure shear wave to conventionally-recorded seismic data in which both source and receivers are located on the earth's surface.

In an alternative embodiment, corresponding recorded signals (i.e., opposite polarity field records) may be added to one another (i.e., “vertically stacked”) after signal enhancements and other modifications are made to each record individually. That is, as before, the recorded data are edited to remove any noisy traces and filtered to reduce noise. The polarity of one the corresponding records (e.g., trace of Plot B of FIG. 5) is reversed (i.e., waveform inverted) and the resulting record is then summed to the other corresponding record (trace of Plot A of FIG. 5). In that manner, the shear wave energy is reinforced while the other data (e.g., P-wave, C-wave, non-random noise) destructively interfere, thereby reducing the record to a S-wave data only, sometimes referred to as a “pure shear wave record”. Polarity information of the shear wave data is lost in this process, but that possible shortcoming may well be offset by the improved computational efficiency.

To reduce these recordings to a pure shear record, the data may be processed as shown in FIG. 5. Field records of opposite S-wave polarity, i.e. the A and B recordings from the same geophone level, may be added to one another (i.e., “vertically stacked”) after signal enhancements and other modifications are made to each record individually. That is the recorded data are edited to remove any noisy traces and filtered to reduce noise. The polarity of one the corresponding records (e.g., trace of Plot B of FIG. 5) is reversed (i.e., waveform inverted) and the resulting record is then summed to the other corresponding record (trace of Plot A of FIG. 5). In that manner, the shear wave energy is reinforced while the other data (e.g., P-wave, converted-wave, non-random noise) destructively interfere, thereby producing S-wave data only. The output of this process is the two-way travel time trace of FIG. 5A.

[Pₜ+S_{T}+nₜ]−[Pₜ−S_{T}+nₜ]=2S_{T}

Where Pₜ is the P-wave or compression wave component of a seismic signal;

S_{T} is the S-wave or shear wave component of a seismic signal

Nₜ is the noise component of a seismic signal.

Next the produced combined pure shear wave recording is then shifted in time to account for the two-way travel time measured for a reflected signal to return to the earth's surface, as shown in Plot F of FIG. 5. The travel time for the direct arrival S-G is added to the earliest sample of the measured S-R-G travel time record to approximate the missing return leg to the earth's surface G-S. Provided that the angle of reflection is not large, less than 5 degrees, the direct arrival travel time will equal the missing return leg travel time of the path S-G and result in the two-way time output trace FIG. 5A.

The two-way time trace produced in the FIG. 5A are then adjusted, by either adding or subtracting time to the beginning of the record, to match the reference elevation datum of the surface P-wave data with which the shear data are to be compared. This allows measurement of time and computations of velocities to be referenced to a common point, which is the P-wave survey datum, and provide meaningful comparison. The shear wave response may now be compared directly with the compression wave response, however the difference in travel times of shear waves and compression waves to the depth of interest make a direct comparison complex. If an adequate table of depth versus shear two-way time and depth versus compression two-way time is available this can be used to identify the times of corresponding events on the shear and compression profiles for direct comparison.

The method of response comparison between the two data recordings is to use the amplitude, frequency or velocity values of the S-wave data and the corresponding P-wave data. Thus by comparison of an individual attribute of the S-wave data to the same attribute of the corresponding location on the P-wave data the likelihood of fluid content in that location may be determined. An example of a simple case would be an amplitude change caused by a subsurface natural gas reservoir on the P-wave section would not be evident on the S-wave profile, which represents a dissimilarity between the S-wave and P-wave data that indicates fluids in the formation. In addition to comparing individual attributes a comparison a comparison of a combination of S-wave attributes with the same combination of P-wave attributes at that location can determine the likelihood of fluid in the formation may also be used. Which attribute or combination of attributes that should be used is dependent on the subsurface conditions.

The field recordings, not the two-way time records, of the direct arrivals in the seismic cone survey are measured to determine the transmission time of the seismic wavefront from the source position to the geophones. From this time the velocity of the intervening strata between the source and receiving geophone are calculated of each separate level of the geophone at which seismic recordings are made. The technique for measurement and computation is described in detailed in ASTM-7400-08 “Standard Test Method for Downhole Testing”.

Using the results of the direct arrival velocity calculations in depth a matrix of shear wave transmission velocities from ground surface to the deepest burial depth of the geophone(s) 14 is developed. This matrix forms the basis for extending the measured interval velocity results below the level of the geophone(s) 14 by integrating the results of the reflections from the horizons below the deepest level of the geophone(s) 14 with the measured transmission velocity matrix in a process known by those skilled in the art as “seismic inversion” of the VShP (vertical shear profile). By commencing the inversion at the deepest continuous formation for which transmission velocities have been measured the result of the inversion is more accurate, more stable and produces a better conversion from shear two-way time to depth than the simple P-wave inversion or inverting the shear wave data starting from the surface 22. Prior to performing the calculations for extending the interval velocities downwards the VShP is refined by removing the effect of the source wavelet, filtered to remove multiples and otherwise signal enhanced before bulk formation densities are estimated to allow the inversion of reflections into the velocity matrix.

The output from this process is a shear two-way time sampled matrix of shear interval velocities extending from the ground surface to the maximum length of the field seismic recording, referred to as the “shear velocity field.” This velocity field is then used to convert the shear wave velocity field from a time sampled velocity matrix to a depth sampled velocity matrix.

The P-wave seismic reflection data is converted to a matrix of reflection coefficients, the sequence of seismic inversion of the P-wave velocities from the surface 22 is applied to convert to a P-wave two way time velocity field. This velocity field is then converted to depth sampling to form a matrix of P-wave velocities in depth.

Using the velocity fields and the related time-depth conversions the following S-wave and P-wave data are compared:
a) The S-wave velocity field sampled in depth for comparison with the P-wave velocity field in depth;
b) The S-wave VShP trace sampled in depth for comparison with the P-wave surface seismic traces sampled in depth;
c) The S-wave reflection coefficient series in depth for comparison with the P-wave reflection coefficient series in depth;

The comparison of these properties in a) allows for velocity anomalies in the P-wave data to be directly compared with velocity anomalies in the VShP at the same depth below datum. If the resulting changes in velocities are similar then the prospective anomalies on the P-wave section are not caused by fluid content and should be downgraded for the reason of increased risk. If they are dissimilar, i.e. a decrease in velocity in the P-wave data without a corresponding decrease in S-wave velocity, the prospect should be upgraded as a velocity decrease is evidence of fluids in the formation.

In a similar fashion in comparing the VShP seismic response in depth with that of the surface P-wave seismic traces in depth in b), a similar wave shapes in the S-wave data to that of shapes in the P-wave data indicates an anomaly, such as a phase change, frequency change or wavelet shape change, that is not caused by fluid content. Whereas the reverse, no S-wave anomaly where a P-wave anomaly exists, indicates a fluid in the formation.

In a similar fashion in comparing the amplitude of the seismic VShP reflection coefficients in depth with the amplitude of the reflection coefficients of the surface P-wave seismic traces in depth in c), a similar sequence in the S-wave data to that of the P-wave data indicates an anomaly that is not caused by fluid content. Whereas the reverse, no S-wave anomaly where a P-wave anomaly exists, indicates a fluid in the formation.

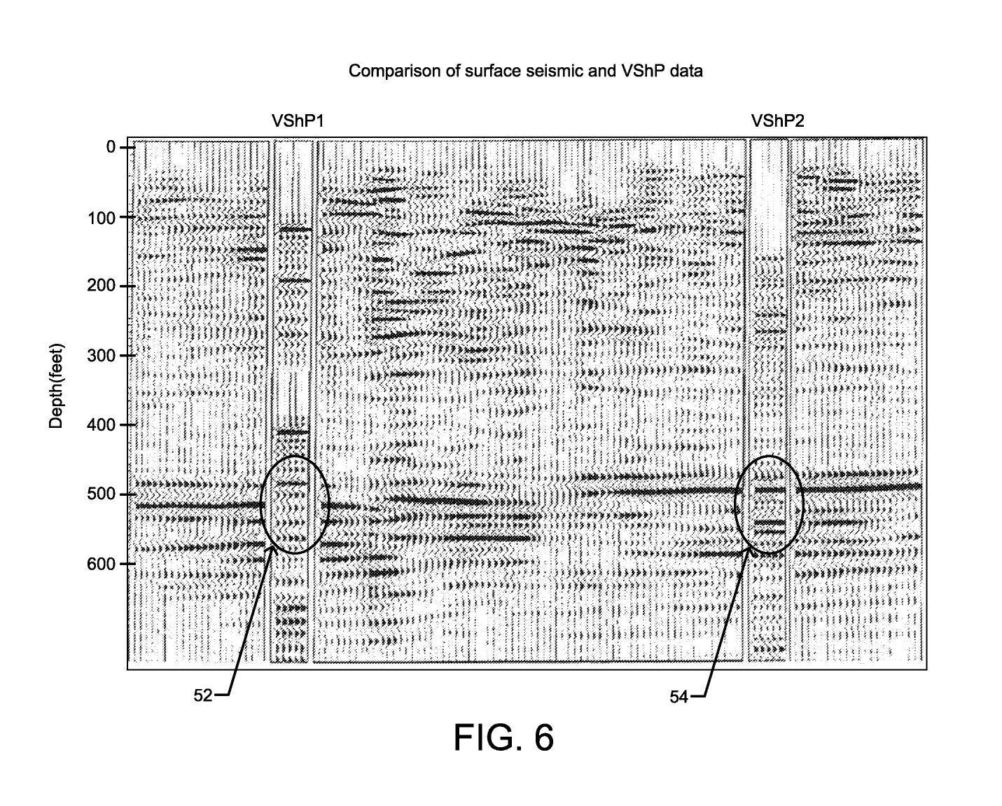

Thus, according to another aspect of the invention, the derived pure shear wave data is applied to portions of a P-wave data recording for the formation of interest 16 in order to help identify potential locations for hydrocarbon reservoirs. FIG. 6 illustrates the application of pure shear wave data to potential reservoir locations. FIG. 6 depicts a surface seismic record 50 for a formation of interest. The surface seismic record 50, the P-wave seismic section in depth, is composed of pure P-waves over recording time from surface to over 600 feet for the section of the formation of interest 16. The section contains two potential hydrocarbon prospect locations 52, 54. The locations 52, 54 are potential hydrocarbon prospects because they demonstrate a positive response to a P-wave seismic signal FIG. 6 illustrates vertical shear profile data (VShP1 and VShP2) being superimposed over the prospect locations 52, 54. The shear profile data VShP1 and VShP2 are pure shear data. The shear profile data VShP1 indicates a negative response to the pure S-wave seismic signal, which indicates the likelihood that the P-wave response is caused by fluids in the first prospect location 52. The shear profile data VShP2 indicates a positive response to the pure S-wave seismic signal, which indicates a change due to lithology or factors other than fluids causing the P-wave response in the second prospect location 54.

A truth table, such as the following one, may be used to evaluate potential hydrocarbon prospect locations in a formation of interest 16 using the methods of the present invention. Various potential prospects can then be ranked in order of viability by comparing velocity, frequency or amplitude characteristics alone or in combination. The P-wave or S-wave response is considered positive when there are anomalies in the recorded signal characteristics, including anomalies in amplitude, frequency content, phase, velocity, or wave shape. Where there are no such anomalies, the response is considered to be negative. As indicated by the following table, an initial positive P-wave response for a given location within the subsurface formation of interest 16 would indicate a potential area that might contain hydrocarbon fluids. In accordance with particular aspects of the present invention, this potential is then further tested by comparing the S-wave response for the same location within the formation of interest 16. The inventor has recognized that a location that has a positive P-wave response as well as a positive S-wave response, it is not a good prospect for hydrocarbon drilling, and drilling of that location should, perhaps, be deferred. On the other hand, if a location has a positive P-wave response, but a negative S-wave response, it is a good prospect for hydrocarbon drilling, and drilling of that location should be prioritized. In this way, potential prospect locations can be ranked or ordered according to their potential for hydrocarbon fluid recovery.

| P-Wave Response | S-Wave Response | Action |
|---|---|---|
| Positive | Negative | Prioritize Drilling |
| Positive | Positive | Defer Drilling |

Those of skill in the art will understand that the invention provides methods for obtaining shear wave seismic data for a subsurface formation wherein a seismic source propagates first and second directional seismic signals of opposite polarity through a subsurface formation. The first and second directional seismic signals are then recorded. The first and second signals are then summed to form a combined signal and a pure shear wave record is derived. Thereafter, the pure shear wave data is used to further identify potential hydrocarbon bearing locations within the formation of interest.

Those of skill in the art will also understand that the invention provides a shear wave acquisition system to obtain shear wave seismic data from a subsurface formation. The system includes a seismic signal generator that can transmit through the subsurface formation first and second directional seismic signals that are opposite in polarity. The system also includes a recorder to record the first and second signals and a processing means to extract a pure shear wave record from a combined signal made up from the first and second signals. In further aspects, the system includes a means for comparing the pure shear wave record to a compression wave record for a potential hydrocarbon reservoir location within the formation by superimposing a vertical shear profile record based upon the pure shear wave record upon a compression wave velocity field in depth.

It should be appreciated that while the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of evaluating potential hydrocarbon prospect locations within a subsurface formation comprising the steps of:
propagating a first directional seismic signal from a shear wave seismic source through the subsurface formation;
propagating a second directional seismic signal from a shear wave seismic source through the subsurface formation, the second direction seismic signal being of opposite polarity from the first directional seismic signal;
recording the first and second directional shear wave seismic signals; and
deriving a pure shear wave two-way time record from the first and second directional seismic signals; and
comparing the pure shear wave record for the first and second directional seismic signals to a compression wave record for the first and second directional seismic signals for a potential hydrocarbon reservoir location within the formation.

2. The method of claim 1 wherein the step of deriving the pure shear wave record further comprises:
inverting the second directional seismic signal record;
adding the inverted second directional seismic signal record to the first directional seismic signal record in order to identify any compression waves and converted waves generated by the seismic source; and
removing the compression waves and converted waves leaving a pure shear wave record.

3. The method of claim 1 wherein:
the step of propagating the first directional seismic signal comprises impacting a shear beam at a first end; and
the step of propagating the second directional seismic signal comprises impacting the shear beam at a second end that is opposite the first end.

4. The method of claim 1 further comprising:
propagating a third directional seismic signal from a seismic source through the subsurface formation;
propagating a fourth directional seismic signal from a seismic source through the subsurface formation, the fourth directional seismic signal being of opposite polarity from the third directional seismic signal;
the third and fourth directional seismic signals being orthogonal to the first and second seismic signals;
recording the third and fourth directional seismic signals;
deriving a pure shear wave record from the third and fourth directional seismic signals; and
comparing the pure shear wave record for the third and fourth directional seismic signals to a compression wave record for the third and fourth directional seismic signal for a potential hydrocarbon reservoir location within the formation.

5. The method of claim 1 wherein the step of comparing the pure shear wave record to a compression wave record for a potential hydrocarbon reservoir location within the formation further comprises superimposing a vertical shear profile record based upon the pure shear wave record upon a compression wave velocity field.

6. The method of claim 1 wherein the first and second directional seismic signals are each recorded for a minimum length of time that is from about 5,000 ms to about 10,000 ms.

7. The method of claim 1 wherein the first and second directional seismic signals are recorded in at least 32-bit fidelity.

8. A method of evaluating potential hydrocarbon prospect locations within a subsurface formation, the method comprising the steps of:
recording first and second opposite directional seismic signals that are propagated through the subsurface formation;
deriving a pure shear wave recording from the first and second directional seismic signals;
identifying potential prospect locations having positive P-wave response within the formation; and
determining which of the potential prospect locations having positive P-wave response also have positive S-wave response using the pure shear wave recording.

9. The method of claim 8 wherein the step of deriving the pure shear wave record further comprises:
adding positive and negative shear wave records to eliminate compression wave and converted wave data and create a combined pure shear wave record; and
adding one-way transit time to the shear record to produce a shear two-way time vertical shear profile.

10. The method of claim 8 wherein the positive P-wave response and positive S-wave response each further comprise an anomaly in at least one of the signal characteristics from the group consisting of amplitude, frequency content, phase, velocity and wave shape.

11. The method of claim 8 wherein the first and second directional seismic signals are each recorded for a minimum length of time that is from about 5,000 ms to about 10,000 ms.

12. The method of claim 8 wherein the first and second directional seismic signals are recorded in at least 32-bit fidelity.

13. A system for evaluating potential hydrocarbon prospects in a subsurface formation, the system comprising:
a seismic signal generator to propagate through the subsurface formation a first directional seismic signal and a second directional seismic signal that is of opposite polarity from the first directional seismic signal;
a recorder for recording the first and second directional seismic signals;
a means for processing the first and second directional seismic signals to extract a pure shear wave record from the first and second directional seismic signals; and
a means for comparing the pure shear wave record to a compression wave record for a potential hydrocarbon reservoir location within the formation.

14. The system of claim 13 wherein the recorder comprises a 32-bit recorder.

15. The system of claim 13 wherein the seismic signal generator comprises:
a shear beam having first end and a second end that is generally opposite the first end; and
an impacting member which can impact each of the first and second ends to respectively generate the first and second directional seismic signals.

16. The system of claim 13 wherein the means for processing comprises a computer.
